(19) United States
(12) Patent Application Publication
(10) Pub. No.: US 2012/0134644 A1
(43) Pub. Date: May 31, 2012

(54) PLAYBACK APPARATUS, PLAYBACK METHOD, AND COMPUTER PROGRAM PRODUCT THEREOF

(75) Inventors: Chia-Wei Liao, Taipei City (TW); Chih-Chun Lai, Taipei City (TW)

(73) Assignee: INSTITUTE FOR INFORMATION INDUSTRY, Taipei (TW)

(21) Appl. No.: 13/028,492

(22) Filed: Feb. 16, 2011

(30) Foreign Application Priority Data
Nov. 29, 2010 (TW) 099141200

(51) Int. Cl. H04N 9/87

(52) U.S. Cl. 386/239; 386/E05.001

(57) ABSTRACT

A playback apparatus, a playback method, and a computer program product thereof are provided. The playback apparatus is adapted to play a video dynamic image. The video dynamic image comprises a dynamic object. The dynamic object has a first selection frame, and moves with a velocity. The playback apparatus comprises a processing unit and an input unit. The processing unit is configured to expand the first selection frame to generate a second selection frame according to the velocity. The input unit is electrically connected to the processing unit and is configured to transmit a selection signal to the processing unit so that the processing unit selects the dynamic object by means of the second selection frame according to the selection signal.

This application claims priority to Taiwan Patent Application No. 099141200 filed on Nov. 29, 2010.

### FIELD

The present invention relates to a playback apparatus, a playback method and a computer program product thereof. More particularly, the present invention relates to a playback apparatus, a playback method and a computer program product thereof for playing a video dynamic image.

### BACKGROUND

In recent years, with rapid development of the Internet and widespread use of various electronic products (e.g., mobile phones, handheld game machines, mobile media players and notebook computers), there are more and more manufacturers and service providers providing the public with a wide variety of audio & video (AV) materials and interactive electronic information. Therefore, electronic information has become the primary source for the modern people to get information, and accordingly, the way in which electronic information is retrieved from the AV materials will deeply affect the habits of people using the electronic products.

Generally, when a user watching an AV material (e.g., a TV program, a movie, a drama or sport broadcasting) encounters a strange or interesting object (e.g., a figure, clothes, a commodity, a scene or an advertisement), he or she may desire to learn the basic information and other derivative information related to the object. With such demands, services of providing and selecting interactive electronic information have appeared.

Conventionally, interactive electronic information is mostly retrieved through menus. As an example, for most of the conventional technologies, when an electronic product is playing an AV material, a menu button on the electronic product is used to call a menu of interactive electronic information on the screen. The menu has related information of objects in the current frame contained therein so that the user can search for interesting options one by one in the menu with naked eyes. However, this conventional way of selection is not intuitive and it takes a lot of time and efforts to search for an interesting option from a menu of a list form. This presents great inconvenience for the user, and discourages the user's desires to use the interactive electronic information and, consequently, degrades the utility of the interactive electronic information.

Accordingly, an urgent need exists in the art to provide a playback method that allows a user to quickly and intuitively select interactive electronic information from an AV material.

### SUMMARY

An objective of the present invention is to provide a playback apparatus. The playback apparatus is adapted to play a video dynamic image. The video dynamic image comprises a first dynamic object, and the first dynamic object has a first selection frame and moves at a velocity. The playback apparatus comprises a processing unit and an input unit. The processing unit is configured to expand the first selection frame according to the velocity to generate a second selection frame. The input unit, which is electrically connected to the processing unit, is configured to transmit a selection signal to the processing unit so that the processing unit selects the first dynamic object by means of the second selection frame according to the selection signal.

Another objective of the present invention is to provide a playback method for a playback apparatus. The playback apparatus is adapted to play a video dynamic image. The video dynamic image comprises a first dynamic object, and the first dynamic object has a first selection frame and moves at a velocity. The playback apparatus comprises a processing unit and an input unit electrically connected to the processing unit. The playback method comprises the following steps of: (a) enabling the processing unit to expand the first selection frame according to the velocity to generate a second selection frame; and (b) enabling the input unit to transmit a selection signal to the processing unit so that the processing unit selects the first dynamic object by means of the second selection frame according to the selection signal.

Yet a further objective of the present invention is to provide a computer program product, which stores a program of a playback method for a playback apparatus. The playback apparatus is adapted to play a video dynamic image. The video dynamic image comprises a first dynamic object, and the first dynamic object has a first selection frame and moves at a velocity. The playback apparatus comprises a processing unit and an input unit electrically connected to the processing unit. The program comprises: a code A for enabling the processing unit to expand the first selection frame according to the velocity to generate a second selection frame; and a code B for enabling the input unit to transmit a selection signal to the processing unit so that the processing unit selects the first dynamic object by means of the second selection frame according to the selection signal.

According to the above descriptions, the present invention can expand a selection frame of a dynamic object in a video dynamic image according to a moving velocity and a movement trajectory of the dynamic object, and select the dynamic object by means of the selection frame according to a selection signal. Furthermore, the present invention can further generate an auxiliary selection frame according to the moving velocity and the movement trajectory of the dynamic object. In this way, when a selection cursor moves into the auxiliary selection frame, the selection cursor is displaced by an auxiliary displacement and when the selection cursor moves into the selection frame, the dynamic object is selected and object information thereof is displayed. Thereby, the present invention can overcome the shortcoming of the prior art that it is difficult to select a dynamic object in a video dynamic image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention;

FIG. 2A is a schematic view of a video frame in the first embodiment of the present invention;

FIG. 2B is a schematic view of a video frame in the first embodiment of the present invention;

FIG. 2C is a schematic view of a video frame in the first embodiment of the present invention;

FIG. 2D is a schematic view of a video frame in the first embodiment of the present invention;

FIG. 2E is a schematic view of a video frame in the first embodiment of the present invention;

FIG. 3 is a schematic view of a selection frame of a dynamic object in the first embodiment of the present invention; and

FIG. 4 is a flowchart of a second embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than limitation. It should be appreciated that, in the following embodiments and the attached drawings, elements not directly related to the present invention are omitted from depiction; and dimensional relationships among individual elements in the attached drawings are illustrated only for ease of understanding, but not to limit the actual scale.

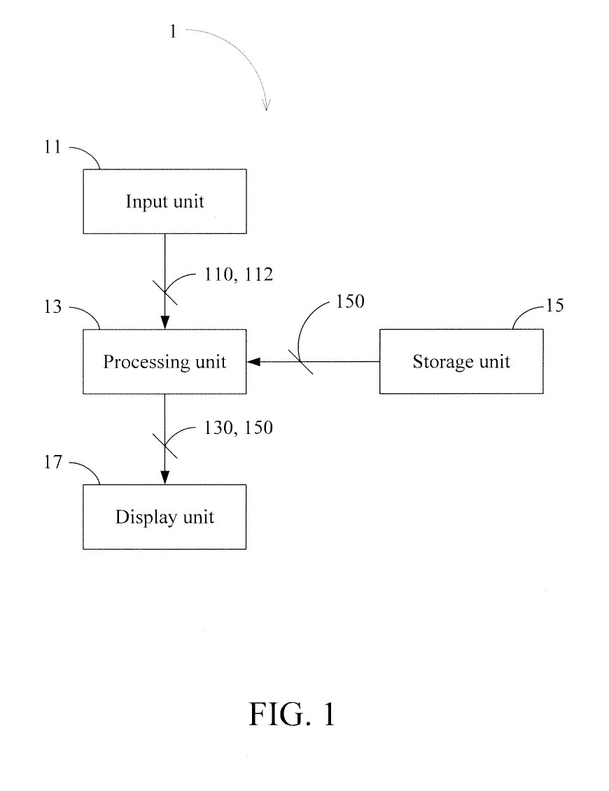

A first embodiment of the present invention is a playback apparatus 1, a schematic view of which is depicted in FIG. 1. The playback apparatus 1 comprises an input unit 11, a processing unit 13, a storage unit 15 and a display unit 17. The input unit 11, the storage unit 15 and the display unit 17 are electrically connected to the processing unit 13 respectively. The storage unit 11 may be a memory, a floppy disk, a hard disk, a compact disk (CD), a mobile disk, a magnetic tape, a database accessible to networks, or any other storage media with the same function and well known to those skilled in the art; and the processing unit 13 may be any of various processors, central processing units (CPUs), microprocessors, calculators or other devices with a calculation capability and well-known to those skilled in the art, either currently available or to be developed in the future.

In this embodiment, the playback apparatus 1 is a notebook computer and the input unit 11 is a mouse. However, in other embodiments, the playback apparatus 1 may also be a TV, a set-top box, a mobile phone, a game machine, a mobile media player or some other playback apparatus capable of playing video dynamic images; and the input unit 11 may also be a remote controller, a touch panel, a laser pen or some other input device capable of transmitting a signal to the playback apparatus 1. Therefore, implementations of the playback apparatus 1 and the input unit 11 are not intended to limit scope of the present invention.

The playback apparatus 1 of the present invention is adapted to play a video dynamic image. By “a video dynamic image” used in the present invention, it means a plurality of video frames played in succession, which may be a TV program, a movie, a drama, sport broadcasting or the like. Contents of the video dynamic image are not intended to limit scope of the present invention. The video dynamic image comprises at least one dynamic object. Depending on contents of the video dynamic image in practical applications, the at least one dynamic object may be various objects appearing in the contents of the video dynamic image, for example, figures, clothes, commodities, scenes, advertisements or the like, and this is not intended to limit scope of the present invention.

Generally, a provider of a video dynamic image may incorporate information related to various objects into the video dynamic image for users to choose to watch. For example, if the video dynamic image comprises a figure, then the provider may incorporate information related to this figure into the video dynamic image, e.g., the name, stature, weight, and the most recent news of this figure; and if the video dynamic image comprises a commodity, then the provider may incorporate advertisements or information of this commodity into the video dynamic image. Information related to objects in the video dynamic image may be adjusted depending on practical needs, but is not intended to limit scope of the present invention.

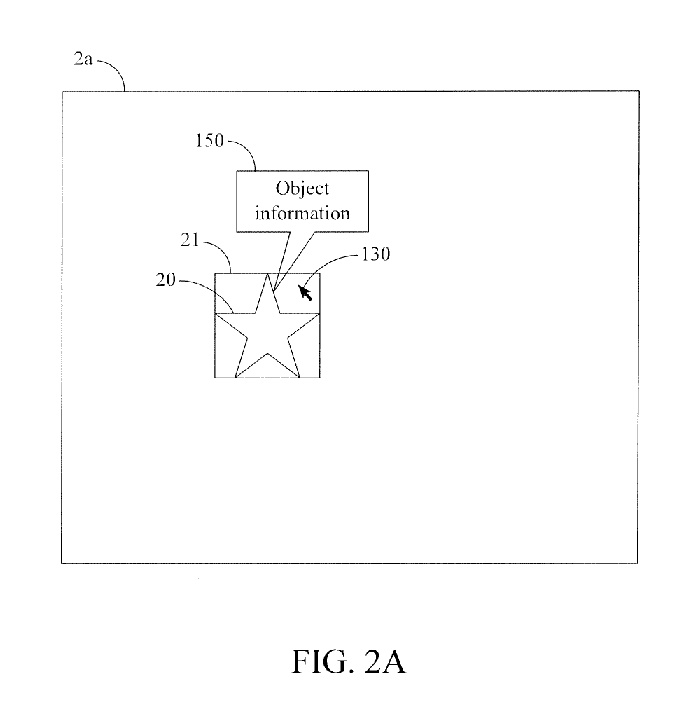

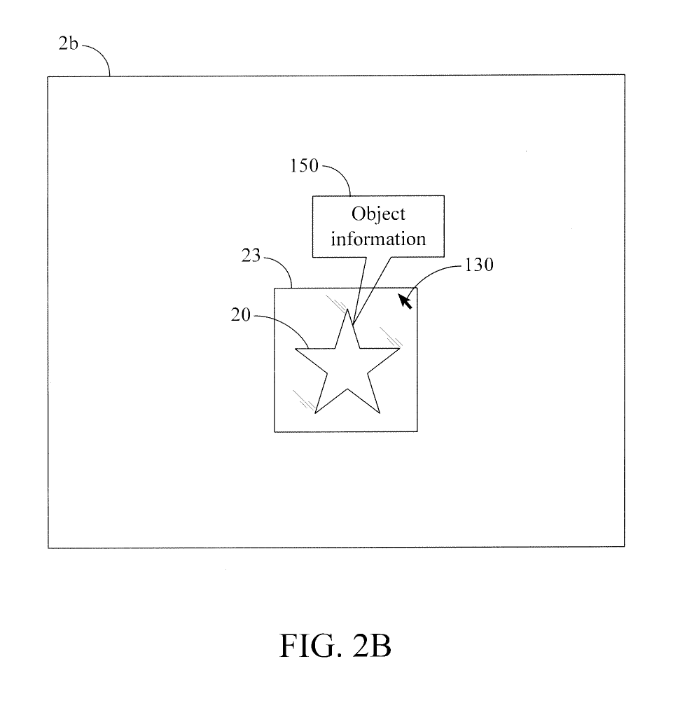

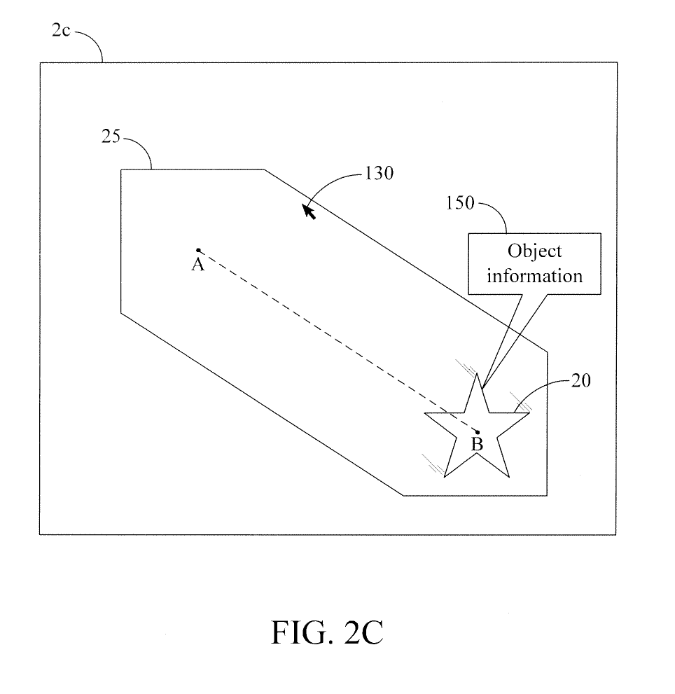

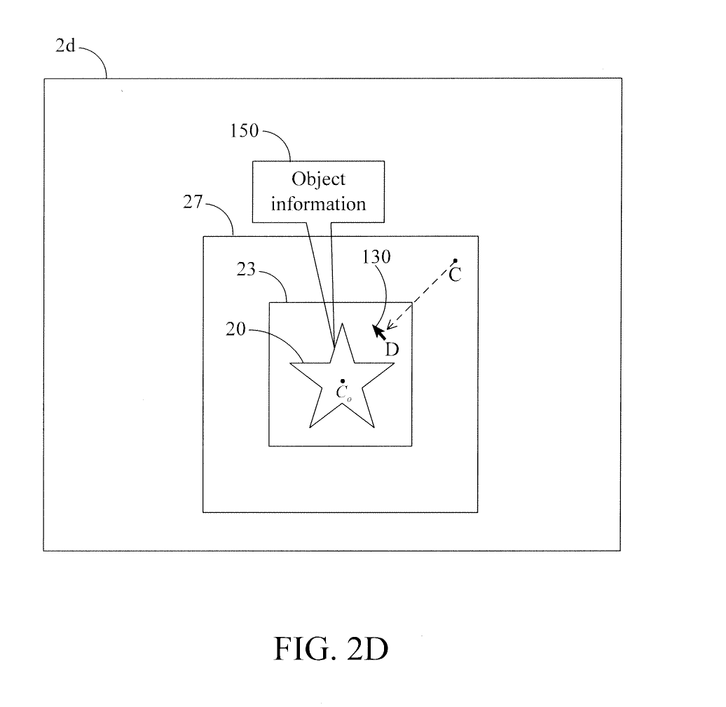

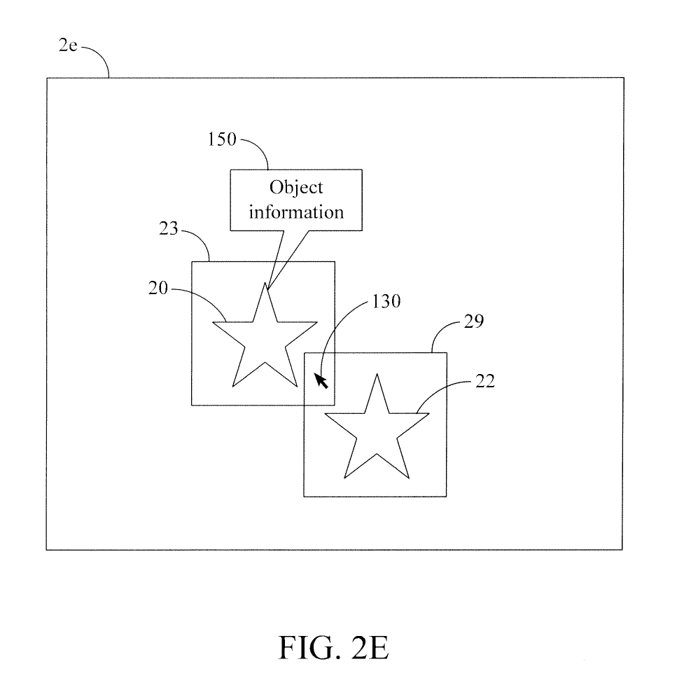

Hereinbelow, how the playback apparatus 1 of the present invention selects a dynamic object comprised in a video dynamic image and display information related to the dynamic object will be described at first. Referring to FIG. 2A, a schematic view of a video frame 2a of a video dynamic image is depicted therein. The video frame 2a comprises a dynamic object 20, which has a selection frame 21. In this embodiment, the selection frame 21 is a rectangle that just encloses a boundary of the dynamic object 20; however, in other embodiments, the selection frame 21 may also be in any other form that can enclose the dynamic object 20. It shall be particularly noted that, for purpose of describing the technical features of the present invention, a selection frame is depicted in each of the video frames in the attached drawings; however, in practical applications, the selection frame may be invisible in the video frames.

Referring to FIG. 1 together, the display unit 17 is configured to display a video frame 2a; the storage unit 15 is configured to store a piece of object information 150 corresponding to the dynamic object 20; the input unit 11 is configured to transmit a selection signal 110 to the processing unit 13; and the processing unit 13 is configured to generate a selection cursor 130 according to the selection signal 110 for display on the display unit 17, as shown in FIG. 2a. When the cursor 130 moves into the selection frame 21, it means that the dynamic object 20 can be selected; then the input unit 11 further transmits a confirming signal 112 to the processing unit 13 so that the processing unit 13 further selects the dynamic object 20 according to the confirming signal 113. Once the dynamic object 20 is selected, the processing unit 13 retrieves the object information 150 corresponding to the dynamic object 20 from the storage unit 15 and displays the object information 150 on the display unit 17. In this way, information related to the dynamic object 20 can be learned by the user.

In other embodiments, when the selection cursor 130 moves into the selection frame 21, the processing unit 13 may directly retrieve the object information corresponding to the dynamic object 20 from the storage unit 15 and display the object information 150 on the display unit 17. In other words, when the selection cursor 130 moves into the selection frame 21, it means that the dynamic object 20 has been selected and, therefore, the processing unit 13 needs not to select the dynamic object 20 through an additional confirming signal.

When the video dynamic image is played by the playback apparatus 11, the dynamic object 20 moves at a velocity in the frame, which makes it more difficult for the user to select the dynamic object 20. In view of this, the playback apparatus 1 of the present invention can further provide an intuitive and efficient way of selecting the dynamic object when the video dynamic image is played. Hereinbelow, how the playback apparatus 1 of the present invention selects a dynamic object contained in a video dynamic image and display information related to the dynamic object when playing the video dynamic image will be detailed.

Firstly, when the video dynamic image is played, the processing unit 13 calculates a movement velocity of the dynamic object 20 according to a playing time of the video dynamic image and a displacement of the dynamic object 20 in the frame. Then, the processing unit 13 expands the selection frame 21 according to the movement velocity of the dynamic object 20 to generate a larger selection frame. Finally, the processing unit 13 can select the dynamic object 20 by means of the larger selection frame.

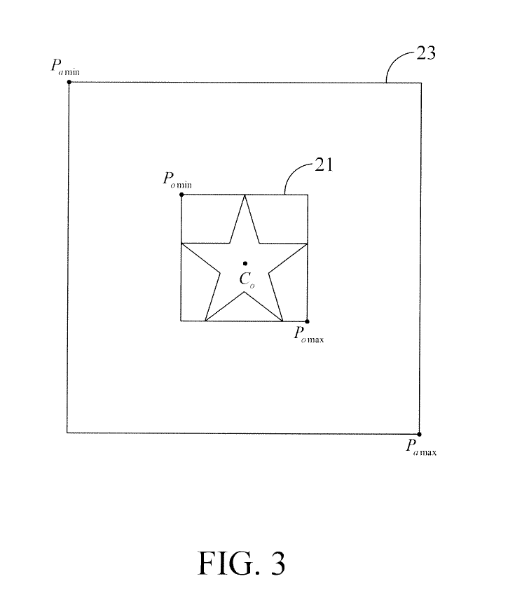

Referring to FIG. 3, a schematic view of a selection frame for the dynamic object is depicted therein. In this embodiment, the selection frame 21 of the dynamic object 20 has a center point coordinate Cₒ(X_{oc}, Y_{oc}) and two diagonal coordinates P_{o max}=(X_{o max}/Y_{o max}) and P_{o min}=(X_{o min}, Y_{o min}), where X_{oc}=(X_{o max}+X_{o min})/2), (Y_{o max}+Y_{o min})/2. The velocity V of the dynamic object 20 may be calculated according to Equation (1) below:

V=(X_{oc,i}=X_{oc,i-1},Y_{oc,i}−Y_{oc,i-1})×N (1)

where, i represents the i^{th} one of a plurality of video frames, N represents the number of video frames played per second by the playback apparatus 1. Accordingly, by calculating a coordinate displacement of the dynamic object 20 within one second, the velocity V of the dynamic object 20 can be calculated.

It shall be noted that, the velocity of the dynamic object 20 may also be provided by the video dynamic image provider; i.e., the video dynamic image provider may calculate, in advance, velocities of dynamic objects in the video dynamic images and provide the velocity information of the dynamic objects to the playback apparatus 1 so that the playback apparatus 1 can directly retrieve the velocity information without calculation.

Next, the processing unit 13 expands the selection frame 21 according to the velocity V to generate a selection frame 23. Specifically, the selection frame 21 has two diagonal coordinates P_{o min} and P_{o max}, and the processing unit calculates two diagonal coordinate points P_{a min} and P_{a max} of the expanded selection frame 23 according to Equation (2) and Equation (3) below:

P_{a max}=P_{o max}+(P_{o max}−Cₒ)×S/K (2)

P_{a min}=P_{o min}+(P_{o min}−Cₒ)×S/K (3)

where, S=∥V∥; S/K is a magnification factor of the selection frame 23 relative to the selection frame 21; K is a predetermined constant value for adjusting the magnification factor. As can be known from Equation (2) and Equation (3), an extent enclosed by the selection frame 23 is directly proportional to the velocity of the dynamic object 20; i.e., the faster the dynamic object 20 moves, the larger the extent enclosed by the selection frame 23 will be.

The video frame 2b with the expanded selection frame is as shown in FIG. 2B. When the dynamic object 20 moves at a velocity, it will have a larger selection frame 23. Then once the selection cursor 130 moves into the selection frame 23, the dynamic object 20 can be selected. This can help to decrease the difficulty in selecting the moving object.

Apart from that the processing unit 13 can expand the selection frame 21 according to the velocity of the dynamic object 20 to generate a selection frame 23, the playback apparatus 1 of the present invention may further expand the selection frame 21 according to a movement trajectory of the dynamic object 20. Referring to FIG. 2C, a schematic view of a video frame 2c with an expanded selection frame is depicted therein. A center point of the dynamic object 20 moves from a coordinate point A to a coordinate point B within a playing time period, and a movement trajectory of the dynamic object 20 is represented by a dashed line in FIG. 2C. The processing unit 13 may further expand the selection frame 23 according to the movement trajectory to generate a selection frame 25. An extent enclosed by the selection frame 25 is an extent covered by the selection frame 23 when moving from the coordinate point A to the coordinate point B, as shown in FIG. 2C. Accordingly, the dynamic object 20 moving at a velocity has a selection frame 25 of a larger extent. Then, when the selection cursor 130 moves into the selection frame 25, the dynamic object will be selected.

For example, the processing unit 13 may record positions and extents of the selection frame 23 in T consecutive video frames, where T=S/M, S=∥V∥, and M is a predetermined constant value for adjusting the number T of the video frames. When the processing unit 13 plays the i^{th} video frame, the processing unit 13 retrieves the extent of the selection frame 23 in the i^{th} video frame and a set of extents of selection frames 23 in the previous T video frames to generate a selection frame 25; i.e., the processing unit 13 combines the extents covered by the selection frame 23 in the plurality of video frames into a selection frame 25. Thereby, the processing unit 13 can generate the selection frame 25 according to the velocity of the dynamic object 20 and the movement trajectory.

In the above example, the extent enclosed by the selection frame 25 is directly proportional to the velocity of the dynamic object 20. The faster the dynamic object 20 moves, the longer the movement trajectory of the dynamic object 20 within one second will be and, accordingly, the larger the extent enclosed by the selection frame 25 will be; on the other hand, the slower the dynamic object 20 moves, the shorter the movement trajectory of the dynamic object 20 within one second will be and, accordingly, the smaller the extent enclosed by the selection frame 25 will be.

Apart from expanding the selection frame of the dynamic object, the playback apparatus 1 of the present invention may further generate an auxiliary selection frame according to the velocity of the dynamic object. In this case, when the selection cursor moves into the auxiliary selection frame, the playback apparatus 1 calculates an auxiliary displacement and moves the selection cursor according to the auxiliary displacement so that the selection cursor can further approach the dynamic object.

Referring to FIG. 2D, a schematic view of a video frame 2d containing an auxiliary selection frame is depicted therein. Firstly, the processing unit 13 generates an auxiliary selection frame. In this embodiment, the processing unit 13 generates the selection frame 23 according to the velocity of the dynamic object 20 as described above, and then directly magnifies the selection frame 23 by a predetermined factor to generate an auxiliary selection frame 27. For example, the processing unit 13 directly magnifies the selection frame 23 by a factor of 1.5 to generate the auxiliary selection frame 27.

In other embodiments, the processing unit 13 may also generate the auxiliary selection frame 27 in other ways. For example, the auxiliary selection frame 27 is generated in the same way that the selection frame 21 is expanded to generate the selection frame 23; i.e., a magnification factor is firstly calculated according to the velocity of the dynamic object 20 and then two diagonal coordinate points of the auxiliary selection frame 27 are calculated according to the magnification factor and two diagonal coordinate points of the selection frame 23 to decide an extent of the auxiliary selection frame 27.

After generation of the auxiliary selection frame 27, when the selection cursor 130 moves to a region between the auxiliary selection frame 27 and the selection frame 25, the processing unit 13 calculates an object weight W according to Equation (4) below:

0≦W=Min(1,(S/Dist)×H)≦1 (4)

where, S=∥V∥; Dist is a distance between the selection cursor 130 and a center point Cₒ of the dynamic object 20; H is a predetermined constant value for adjusting the object weight W. The object weight W obtained from Formula (4) ranges between 0 and 1.

It shall be appreciated that, each dynamic object in a video dynamic image may have a respective priority. For example, if a dynamic object is a product that is to be preferentially promoted by the video dynamic image provider, then the dynamic object has a higher priority and, therefore, the object weight of this dynamic object may be increased by increasing the value of H; conversely, if a dynamic object is an out-of-season product, then the dynamic object shall have a lower priority and therefore, the object weight of this dynamic object may be lowered by decreasing the value of H. Depending on practical applications, the object weights of dynamic objects in a video dynamic image may be adjusted according to priorities of these dynamic objects. Additionally, the processing unit 13 may further determine whether the selection cursor 130 is located within an extent of a movement trajectory of the dynamic object 20; if the answer is “yes”, then it means that the user may desire to select the dynamic object 20, so the processing unit 13 can appropriately increase the object weight W.

When the selection cursor 130 moves into the auxiliary selection frame 27, the processing unit 13 will also calculate a cursor displacement D_{cursor}=(X_{d}, Y_{d}) of the selection cursor 130 in the auxiliary selection frame 27, where X_{d} is a cursor displacement in the x direction and Y_{d} is a cursor displacement in the y direction.

After calculation of the object weight W, the processing unit 13 then calculates an auxiliary displacement D_{aid} according to Equation (5) below:

D_{aid}=D_{cursor}×(1−W)+(C_{o,i-1}−Cursorᵢ₋₁)×W (5)

where, C_{o,i-1} is a coordinate of a center point of the dynamic object 20 in the (i−1)^{th} video frame, and Cursorᵢ₋₁ is a coordinate of the selection cursor 130 in the (i−1)^{th} video frame.

Next, the processing unit 13 calculates a coordinate of the selection cursor 130 displaced by the auxiliary displacement D_{aid} according to Equation (6) below:

Cursorᵢ=Cursorᵢ₋₁+D_{aid} (6)

Finally, the processing unit 13 moves the selection cursor 130 from a position C to a position D according to the calculation result of Equation (6). Thus, when the selection cursor 130 moves into the auxiliary selection frame 27, it can be moved closer to the dynamic object 20 according to an auxiliary displacement so that the user can select the moving dynamic object 20 more easily.

In another embodiment, the input unit 11 may be a touch panel, in which case the coordinate of the selection cursor is decided by a position where the user touches the touch panel. Hence, when the user touches within a region between the auxiliary selection frame 27 and the selection frame 25, the selection cursor 130 will appear in the auxiliary selection frame 27 straightforwardly without having to be displaced by the aforesaid cursor displacement. Accordingly, in such an embodiment, the processing unit 13 may calculate the coordinate of the selection cursor 130 after the auxiliary displacement according to Equation (7) below instead:

Cursorᵢ=Pᵢ×(1−W)+C_{o,i}×W (7)

where, Pᵢ is a coordinate of the selection cursor 130 in the i^{th} video frame, and C_{o,i} is a coordinate of the center point of the dynamic object 20 in the i^{th} video frame. In such an embodiment, the selection cursor 130 is for use by the processing unit 13 to determine whether the dynamic object 20 is selected and may be invisible on the display unit 17.

On the other hand, in practical applications, the video dynamic image may comprise a plurality of dynamic objects, each of which has a selection frame respectively. When the dynamic objects move respectively, it is likely that multiple selection frames overlap each other in a video frame. In view of this, the playback apparatus 1 of the present invention is further configured to, when the selection cursor moves to a position where multiple selection frames overlap each other, select one of dynamic objects corresponding to the overlapped selection frames according to a selection rule, so as to avoid simultaneous selection of multiple dynamic objects that would otherwise cause chaos in the frame.

Referring to FIG. 2E, a schematic view of a video frame 2e containing two dynamic objects is depicted therein. The video frame 2e comprises a dynamic object 20 and a dynamic object 22. The dynamic object 20 has a selection frame 23, and the dynamic object 22 has a selection frame 29. As can be seen from FIG. 2E, the selection frame 23 and the selection frame 29 have an overlapped region, and currently the selection cursor 130 is located within the overlapped region.

In such a case, the processing unit 13 may firstly determine which dynamic object shall be preferentially selected according to the aforesaid object weights W. For example, the dynamic object 20 has an object weight W=0.8, and the dynamic object 22 has an object weight W=0.5. Then, the processing unit 13 determines that the dynamic object 20 has a higher object weight and, accordingly, selects the dynamic object 20 and displays object information of the dynamic object 20 on the display unit 17.

Apart from determining which dynamic object shall be preferentially selected according to the object weights W, the processing unit 13 may further make this determination according to other rules. Specifically, the processing unit 13 may further decide a priority sequence according to distances between the selection cursor 130 and respective center points of the dynamic objects. For example, if a distance between the selection cursor 130 and the center point of the dynamic object 20 is smaller than that between the selection cursor 130 and the center point of the dynamic object 22 (i.e., the selection cursor 130 is closer to the dynamic object 20), then the processing unit 13 determines that the dynamic object 20 has a higher priority and, accordingly, selects the dynamic object 20 and displays object information of the dynamic object 20 on the display unit 17.

In another example, the processing unit 13 may further decide a priority sequence according to sizes of dynamic objects in a video frame. For example, if a size of the dynamic object 20 in a video frame is smaller than that of the dynamic object 22 in the video frame (i.e., the dynamic object 20 is a dynamic object that is more difficult to be selected in the video frame), then the processing unit 13 determines that the dynamic object 20 has a higher priority and, accordingly, selects the dynamic object 20 and displays object information of the dynamic object 20 on the display unit 17.

In a further example, the processing unit 13 may further decide a priory sequence according to velocities of dynamic objects. For example, if a velocity of the dynamic object 20 is higher than that of the dynamic object 22 (i.e., the dynamic object 20 is a dynamic object that is more difficult to be selected), then the processing unit 13 determines that the dynamic object 20 has a higher priority and, accordingly, selects the dynamic object 20 and displays object information of the dynamic object 20 on the display unit 17. In other embodiments, the processing unit 13 may further decide a priority sequence of dynamic objects in a video dynamic image according to other selection rules, and scope of the present invention is not limited by the selection rules.

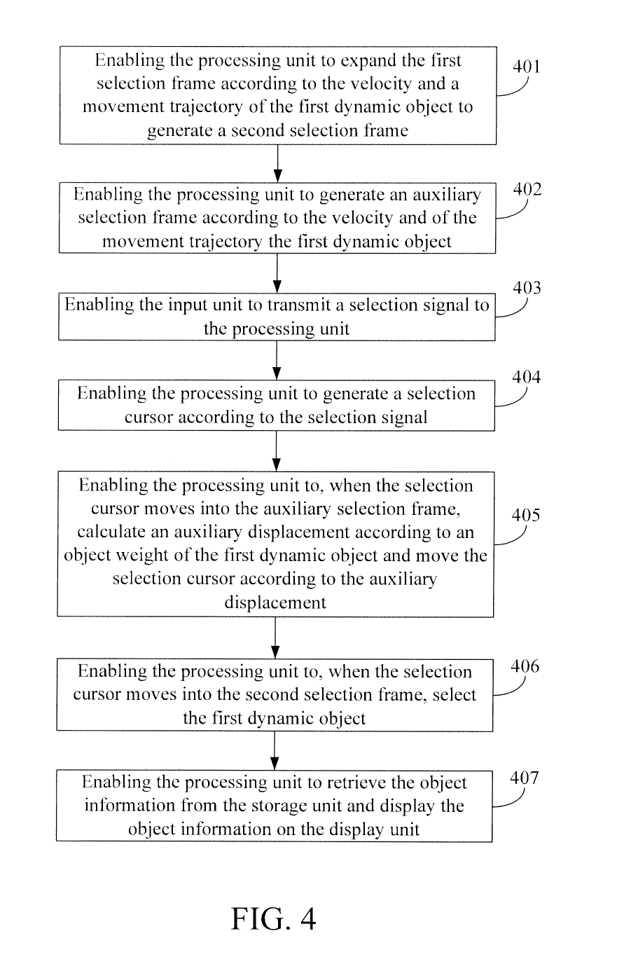

FIG. 4 shows a second embodiment of the present invention which is a playback method for the playback apparatus as described in the first embodiment. The playback apparatus is adapted to play a video dynamic image. The video dynamic image comprises a first dynamic object, which has a first selection frame and moves at a velocity. The playback apparatus comprises a processing unit and an input unit electrically connected to the processing unit.

Further, the playback method described in the second embodiment may be implemented by a computer program product. When the computer program product is loaded into the playback apparatus and a plurality of codes comprised in the computer program product is executed, the playback method described in the second embodiment can be accomplished. The computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

FIG. 4 depicts a flowchart of a playback method according to the second embodiment. Firstly, the playback method executes step 401 to enable the processing unit to expand the first selection frame according to the velocity and a movement trajectory of the first dynamic object to generate a second selection frame. Then, step 402 is executed to enable the processing unit to generate an auxiliary selection frame according to the velocity and the movement trajectory of the first dynamic object.

Next, step 403 is executed to enable the input unit to transmit a selection signal to the processing unit, and step 404 is executed to enable the processing unit to generate a selection cursor according to the selection signal.

Thereafter, step 405 is executed to enable the processing unit to, when the selection cursor moves into the auxiliary selection frame, calculate an auxiliary displacement according to an object weight of the first dynamic object and move the selection cursor according to the auxiliary displacement. Then, step 406 is executed to enable the processing unit to, when the selection cursor moves into the second selection frame, select the first dynamic object. Finally, step 407 is executed to enable the processing unit to retrieve the object information from the storage unit and display the object information on the display unit.

In practical applications, the video dynamic image may further comprise a second dynamic object, which has a third selection frame. In this case, the playback method may further comprise step 408 (not shown in FIG. 4). Step 408 is executed to enable the processing unit to, when the third selection frame overlaps the first selection frame, select the first dynamic object according to a selection sequence.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, the present invention can expand a selection frame of a dynamic object in a video dynamic image according to a movement velocity and a movement trajectory of the dynamic object in the video dynamic image, and generate an auxiliary selection frame according to the movement velocity and the movement trajectory of the dynamic object so that when a selection cursor moves into the auxiliary selection frame, the selection cursor is displaced by an auxiliary displacement and when the selection cursor moves into the selection frame, the dynamic object is selected and object information thereof is displayed. Thereby, the present invention overcomes the shortcoming of the prior art that it is difficult to select a dynamic object in a video dynamic image, and further has such advantages as easy operation, intuitive selection, saving of time and improved users' desire to use the interactive electronic information.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A playback apparatus adapted to play a video dynamic image, the video dynamic image comprising a first dynamic object, the first dynamic object having a first selection frame and moving at a velocity, the playback apparatus comprising:
a processing unit, being configured to expand the first selection frame according to the velocity to generate a second selection frame; and
an input unit electrically connected to the processing unit, being configured to transmit a selection signal to the processing unit so that the processing unit selects the first dynamic object by means of the second selection frame according to the selection signal.

2. The playback apparatus as claimed in claim 1, wherein the processing unit calculates a magnification factor according to the velocity, and expands the first selection frame according to the magnification factor to generate the second selection frame.

3. The playback apparatus as claimed in claim 1, wherein the processing unit is further configured to generate the second selection frame by expanding the first selection frame according to a movement trajectory of the first dynamic object.

4. The playback apparatus as claimed in claim 1, further comprising a storage unit and a display unit which are electrically connected to the processing unit respectively, wherein the storage unit is configured to store a piece of object information corresponding to the first dynamic object, and the processing unit is further configured to display the object information on the display unit when the first dynamic object is selected.

5. The playback apparatus as claimed in claim 1, wherein the processing unit is further configured to generate a selection cursor according to the selection signal and, when the selection cursor moves into the second selection frame, select the first dynamic object.

6. The playback apparatus as claimed in claim 5, wherein the processing unit is further configured to generate an auxiliary selection frame according to the velocity and, when the selection cursor moves into the auxiliary selection frame, calculate an auxiliary displacement according to an object weight of the first dynamic object and move the selection cursor according to the auxiliary displacement.

7. The playback apparatus as claimed in claim 6, wherein the processing unit is further configured to generate the auxiliary selection frame according to a movement trajectory of the first dynamic object.

8. The playback apparatus as claimed in claim 1, wherein the video dynamic image further comprises a second dynamic object having a third selection frame, and the processing unit is further configured to select the first dynamic object according to a selection sequence when the third selection frame overlaps the first selection frame.

9. A playback method for a playback apparatus, the playback apparatus being adapted to play a video dynamic image, the video dynamic image comprising a first dynamic object, the first dynamic object having a first selection frame and moving at a velocity, the playback apparatus comprising a processing unit and an input unit electrically connected to the processing unit, the playback method comprising the following steps of:
(a) enabling the processing unit to expand the first selection frame according to the velocity to generate a second selection frame; and
(b) enabling the input unit to transmit a selection signal to the processing unit so that the processing unit selects the first dynamic object by means of the second selection frame according to the selection signal.

10. The playback method as claimed in claim 9, wherein the step (a) is a step of enabling the processing unit to calculate a magnification factor according to the velocity and expand the first selection frame according to the magnification factor to generate the second selection frame.

11. The playback method as claimed in claim 9, further comprising the following step of:
(c) enabling the processing unit to generate the second selection frame by expanding the first selection frame according to a movement trajectory of the first dynamic object.

12. The playback method as claimed in claim 9, wherein the playback apparatus further comprises a storage unit and a display unit which are electrically connected to the processing unit respectively, and the storage unit is configured to store a piece of object information corresponding to the first dynamic object, the playback method further comprising the following step of:
(c) when the first dynamic object is selected, enabling the processing unit to retrieve the object information from the storage unit and display the object information on the display unit.

13. The playback method as claimed in claim 9, further comprising the following steps of:
(e) enabling the processing unit to generate a selection cursor according to the selection signal; and
(f) when the selection cursor moves into the second selection frame, enabling the processing unit to select the first dynamic object.

14. The playback method as claimed in claim 13, further comprising the following steps of:
(g) enabling the processing unit to generate an auxiliary selection frame according to the velocity; and
(h) when the selection cursor moves into the auxiliary selection frame, enabling the processing unit to calculate an auxiliary displacement according to an object weight of the first dynamic object and move the selection cursor according to the auxiliary displacement.

15. The playback method as claimed in claim 14, wherein the step (g) is a step of enabling the processing unit to generate the auxiliary selection frame according to the velocity and a movement trajectory of the first dynamic object.

16. The playback method as claimed in claim 9, wherein the video dynamic image further comprises a second dynamic object having a third selection frame, the playback method further comprising the following step of:
(i) enabling the processing unit to select the first dynamic object according to a selection sequence when the third selection frame overlaps the first selection frame.

17. A computer program product, storing a program of a playback method for a playback apparatus, the playback apparatus being adapted to play a video dynamic image, the video dynamic image comprising a first dynamic object, the first dynamic object having a first selection frame and moves at a velocity, the playback apparatus comprising a processing unit and an input unit electrically connected to the processing unit, the program comprising:
a code A for enabling the processing unit to expand the first selection frame according to the velocity to generate a second selection frame; and
a code B for enabling the input unit to transmit a selection signal to the processing unit so that the processing unit selects the first dynamic object by means of the second selection frame according to the selection signal.

18. The computer program product as claimed in claim 17, wherein the code A is a code for enabling the processing unit to calculate a magnification factor according to the velocity and expand the first selection frame according to the magnification factor to generate the second selection frame.

19. The computer program product as claimed in claim 17, wherein the program further comprises:
a code C for enabling the processing unit to generate the second selection frame by expanding the first selection frame according to a movement trajectory of the first dynamic object.

20. The computer program product as claimed in claim 17, wherein the playback apparatus further comprises a storage unit and a display unit which are electrically connected to the processing unit respectively, the storage unit is configured to store a piece of object information corresponding to the first dynamic object, the playback method further comprising the following step of:
a code D for, when the first dynamic object is selected, enabling the processing unit to retrieve the object information from the storage unit and display the object information on the display unit.

21. The computer program product as claimed in claim 17, wherein the program further comprises:
a code E for enabling the processing unit to generate a selection cursor according to the selection signal; and
a code F for, when the selection cursor moves into the second selection frame, enabling the processing unit to select the first dynamic object.

22. The computer program product as claimed in claim 21, wherein the program further comprises:
a code G for enabling the processing unit to generate an auxiliary selection frame according to the velocity; and
a code H for, when the selection cursor moves into the auxiliary selection frame, enabling the processing unit to calculate an auxiliary displacement according to an object weight of the first dynamic object and move the selection cursor according to the auxiliary displacement.

23. The computer program product as claimed in claim 22, wherein the code G is a code for enabling the processing unit to generate the auxiliary selection frame according to the velocity and a movement trajectory of the first dynamic object.

24. The computer program product as claimed in claim 17, wherein the video dynamic image further comprises a second dynamic object having a third selection frame, and the program further comprises:
a code I for enabling the processing unit to select the first dynamic object according to a selection sequence when the third selection frame overlaps the first selection frame.
